(19) United States
(12) Patent Application Publication
(10) Pub. No.: US 2026/0019839 A1
(43) Pub. Date: Jan. 15, 2026

(54) UE CAPABILITY FOR INTER-RAT MEASUREMENTS WITHOUT GAPS

(71) Applicant: Intel Corporation, Santa Clara, CA (US)

(72) Inventors: Rui Huang, Beijing (CN); Meng Zhang, Beijing (CN); Hua Li, Beijing 11 (CN); In-Seok Hwang, Santa Clara, CA (US)

(21) Appl. No.: 18/881,079

(22) PCT Filed: Jul. 31, 2023
(86) PCT No.: PCT/US2023/029119

§ 371 Date: Jan. 3, 2025

Related U.S. Application Data
(60) Provisional application No. 63/394,917, filed on Aug. 3, 2022.

(51) Int. Cl. H04W 24/08

(52) U.S. Cl. CPC H04W 24/08

(57) ABSTRACT

A user equipment (UE) configured for operation in a 5G NR network may be capable of operating in accordance two or more radio-access technologies (RATs) including a first RAT and a second RAT. The UE may encode a UE capability information element for transmission to a serving cell indicating whether the UE has a capability for performing inter-RAT measurements without measurement gaps. When the UE indicated the capability for performing inter-RAT measurements without measurement gaps, the UE may be configured to simultaneously measure signals of the second RAT in a second frequency band while receiving data or while transmitting data in accordance with the first RAT in a first frequency band. When the UE is performing inter-RAT measurements without measurement gaps, the UE may temporarily pause transmission of acknowledgements (ACKs) and negative ACKs (NACKs) (ACK/NACKs) for the data received in accordance with the first RAT during the measurement of the signals of the second RAT.

### PRIORITY CLAIM

This application claims priority to U.S. Provisional Patent Application Ser. No. 63/394,917, filed Aug. 3, 2022 [reference number AE6828-Z] which is incorporated herein by reference in its entirety.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Measurement gaps are opportunities given to a UE to perform measurements on downlink signals. A UE conventionally cannot perform inter-frequency or inter-RAT measurements while also transmitting or receiving. Even for intra-frequency measurements, a 5G UE may require measurement gaps if such measurements are to be performed outside the UE's currently active Bandwidth Part (BWP).

One issue with measurement gaps is that they reduce the amount of uplink or downlink data that can be transmitted or received by a UE. Therefore, it would be desirable for a UE to be able to perform inter-frequency and inter-RAT measurements without measurement gaps.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates measurement gaps, in accordance with some embodiments; and

FIG. 3 illustrates a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments disclosed here relate to UEs that are able to perform inter-frequency and inter-RAT measurements without measurement gaps. These embodiments are discussed in more detail below.

Some embodiments are directed to a UE configured for operation in a 5G NR network. In these embodiments, the UE may be capable of operating in accordance two or more radio-access technologies (RATs) including a first RAT and a second RAT. In these embodiments, the UE may encode a UE capability information element for transmission to a serving cell. The UE capability information element may indicate whether the UE has a capability for performing inter-RAT measurements without measurement gaps. In these embodiments, when the UE indicated the capability for performing inter-RAT measurements without measurement gaps, the UE may be configured to simultaneously measure signals of the second RAT in a second frequency band while receiving data or while transmitting data in accordance with the first RAT in a first frequency band. These embodiments, as well as others, are described in more detail herein.

In some embodiments, when the UE is performing inter-RAT measurements without measurement gaps, the UE may be configured to temporarily pause transmission of acknowledgements (ACKs) and negative ACKs (NACKs) (ACK/NACKs) for the data received in accordance with the first RAT during the measurement of the signals of the second RAT. These embodiments, as well as others, are also described in more detail herein.

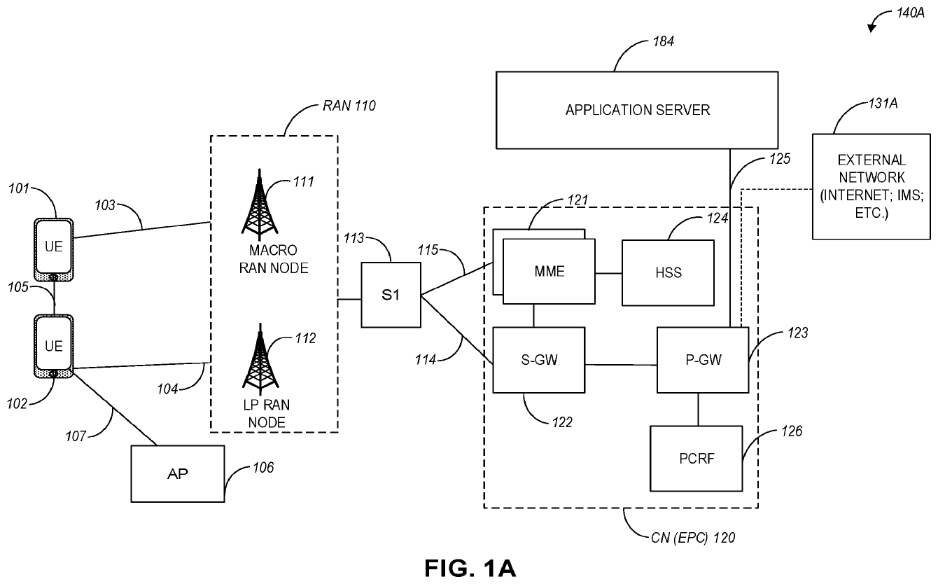

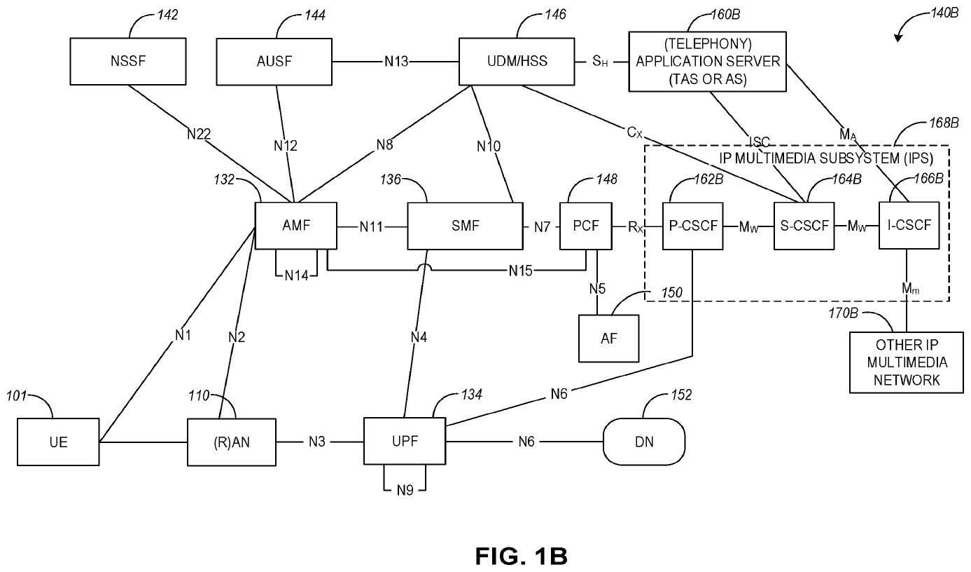

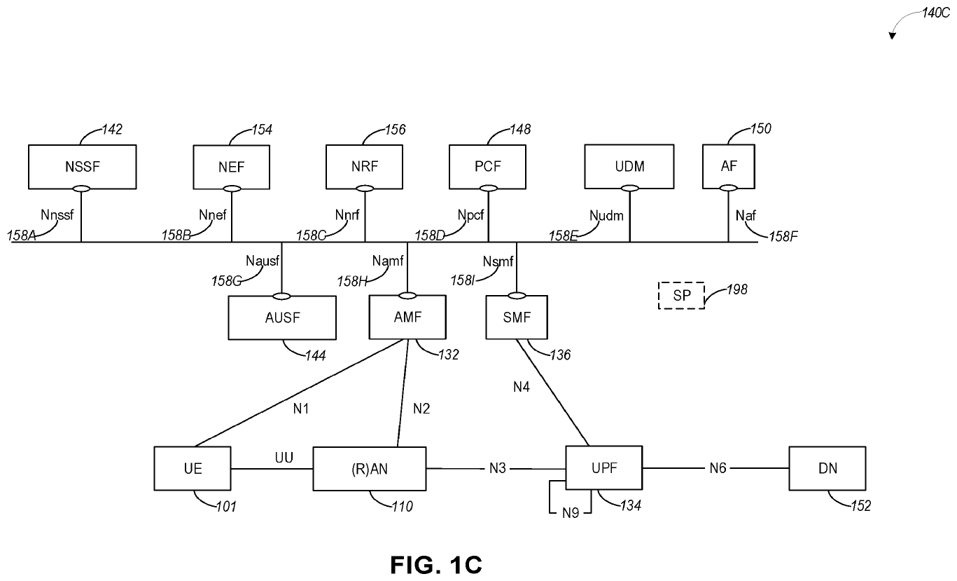

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. The application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. In these embodiments, the RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

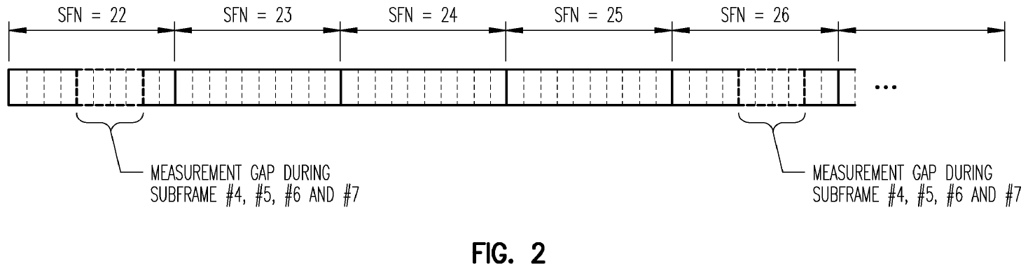

FIG. 2 illustrates measurement gaps, in accordance with some embodiments. The example illustrated in FIG. 2 shows measurement gaps occurring in subframes numbers 4, 5, 6 and 7 of system frame numbers (SFNs) 22 and 26.

Embodiments disclosed here relate to UEs that are able to perform inter-frequency and inter-RAT measurements without measurement gaps. Embodiments disclosed herein relate to a UE capability for performing inter-frequency and inter-RAT measurements without measurement gaps. Some embodiments are directed to a UE configured for performing inter-frequency and inter-RAT measurements without measurement gaps.

Some embodiments disclosed herein relate to enhancements of pre-configured MGs, multiple concurrent MGs and network configured small gaps (NCSGs). In these embodiments, the radio-resource management (RRM) requirements for UEs configured with a combination of pre-configured MGs, and/or multiple concurrent MGs and/or NCSG may be defined. The joint requirements for UE configured with pre-configured MGs and multiple concurrent MGs (i.e., concurrent MGs where at least one of the gaps is a pre-configured gap) may be prioritized as well as NCSG and multiple concurrent MGs (i.e., concurrent MGs where at least one of the gaps is NCSG).

Some embodiments relate to RRM requirements for measurements without measurement gaps for NR SSB-based inter-frequency and intra-frequency measurements without measurement gaps for UEs reporting NeedForGapsInfoNR IE.

In some embodiments, an additional interruption may be allowed when a UE is reporting a ‘NeedForGapsInfoNR’. The interruption length, occasion and ratio, if the interruption is allowed, may further be defined. In some embodiments, requirements, such as a Carrier-Specific Scaling Factor (CSSF), a measurement period, and a scheduling restriction, may also be defined.

In some embodiments, a new UE capability may be introduced for inter-RAT E-UTRAN measurements. In these embodiments, a separate UE basic capability to support the inter-RAT measurements without measurement gaps may be defined. Furthermore, additional UE capabilities may be provided in addition to a basic UE capability to support the inter-RAT measurements. For example, a UE capability to support a mixed numerology between LTE and NR, and a UE searcher processing capability may be provided.

In some embodiments, inter-RAT measurements without measurement gaps are supported by a separate basic UE capability. Other UE capabilities to support inter-RAT measurements without measurement gaps may also be supported.

In some embodiments, inter-RAT E-UTRAN measurement may only consider the case when LTE CRS to be measured is contained in UE's active BWP. In these embodiments, a UE may perform inter-RAT LTE measurements without measurement gaps when the UE has an unused or vacant RF chain. In another scenario, the LTE CRSs may be contained in UE's active BWP allowing for gap-less measurements. In these embodiments, no interruption is allowed for this kind of gap-less measurements on target E-UTRA carrier.

In some embodiments, an inter-RAT E-UTRAN measurement only considers the case when LTE CRS to be measured are contained in UE's active BWP. In these embodiments, for inter-RAT NR measurements, an LTE UE (with stand-along SA capability) may be configured to measure FR2 NR frequency layers.

The following information elements are disclosed:

interRAT-NeedForGaps:

Indicates need for DL measurement gaps when operating on the E-UTRA band given by the entry in bandListEUTRA or on the E-UTRA band combination given by the entry in bandCombinationListEUTRA and measuring on the inter-RAT band given by the entry in the interRAT-BandList.

interRAT-NeedForGapsNR:

Indicates need for measurement gaps when operating on the E-UTRA band given by the entry in supportedBandListEUTRA or on the E-UTRA band combination given by the entry in supportedBandCombination-r10 or supportedBandCombinationAdd-r11 or supportedBandCombinationReduced-r13 and measuring on the NR band given by the entry in the InterRAT-BandListNR.

Some embodiments disclosed herein provide some initial views on the necessary RRM requirements because of inter-RAT measurements without measurement gaps below.

The existing inter-RAT measurement requirements in TS38.133 9.4 for cell identification and measurement reporting are only based on the measurements within gap as given below.

$${T}_{Identify , E - UTRAN FDD} = {T}_{BasicIdentify} \cdot \frac{480}{{T}_{Inter 1}} \cdot {CSSF}_{interRAT} ms$$

Parameter T_{Inter1} used in inter-RAT requirements in clause 9.4 is specified in Table 9.4.1-1 when measurement gap is used, and in Table 9.4.1-2 when NCSG is used.

TABLE 9.4.1-1
Minimum available time for inter-RAT measurements
when a measurement gap is configured.

| | | | Minimum |
|---|---|---|---|
| | | | available time |
| | | | for inter- |
| | | | frequency and |
| | | Measurement | inter-RAT |
| | | Gap | measurements |
| Gap | Measurement | Repetition | during 480 |
| Pattern | Gap Length | Period | ms period |
| Id | (MGL, ms) | (MGRP, ms) | (Tinter1, ms) |
| 0 | 6 | 40 | 60 |
| 1 | 6 | 80 | 30 |
| 2 | 3 | 40 | 24^{Note 1} |
| 3 | 3 | 80 | 12^{Note 1} |
| 4 | 6 | 20 | 120^{Note 1} |
| 6 | 4 | 20 | 72^{Note 1, 3, 6} |
| 7 | 4 | 40 | 36^{Note 1, 4, 6} |
| 8 | 4 | 80 | 18^{Note 1, 5, 6} |
| 10 | 3 | 20 | 48^{Note 1} |

^{NOTE 1}
When determining UE requirements using Tinter1 for gap pattern IDs 2, 3, 4, 6, 7, 8, 10, Tinter1 = 60 for gap pattern IDs 2, 4, 6, 7, 10, and Tinter1 = 30 for gap pattern IDs 3 and 8 shall be used.
NOTE 2:
Measurement gaps pattern configurations applicability is as specified in Table 9.1.2-1.
^{NOTE 3}
When this gap pattern is used, the Tᵢₙₜₑᵣ for E-UTRA inter-frequency measurements is 48 ms corresponding to the first 3 ms of the 4 ms gap.
^{NOTE 4}
When this gap pattern is used, the Tᵢₙₜₑᵣ for E-UTRA inter-frequency measurements is 24 ms corresponding to the first 3 ms of the 4 ms gap.
^{NOTE 5}
When this gap pattern is used, the Tᵢₙₜₑᵣ for E-UTRA inter-frequency measurements is 12 ms corresponding to the first 3 ms of the 4 ms gap.
^{NOTE 6}
This gap pattern is applicable for E-UTRA inter-frequency measurements only if gap based NR measurements are also configured.
NOTE 7:
If multiple concurrent gaps are configured, the MGRP is the periodicity of the MG pattern associated to the E-UTRA inter-RAT frequency layers.

TABLE 9.4.1-2
Minimum available time for inter-RAT
measurements when NCSG is configured.

| | | | Minimum |
|---|---|---|---|
| | | | available time |
| | | | for inter- |
| | | | frequency and |
| | | Visible | inter-RAT |
| | | Interruption | measurements |
| NCSG | Measurement | Repetition | during 480 |
| Pattern | Length | Period | ms period |
| Id | (ML, ms) | (VIRP, ms) | (Tinter1, ms) |
| 0 | 5 | 40 | 60 |
| 1 | 5 | 80 | 30 |
| 2 | 2 | 40 | 24^{Note 1} |
| 3 | 2 | 80 | 12^{Note 1} |
| 4 | 5 | 20 | 120^{Note 1} |
| 6 | 3 | 20 | 72^{Note 1, 3} |
| 7 | 3 | 40 | 36^{Note 1, 3} |
| 8 | 3 | 80 | 18^{Note 1, 3} |
| 10 | 2 | 20 | 48^{Note 1} |

^{NOTE 1}
When determining UE requirements using Tinter1 for NCSG pattern IDs 2, 3, 4, 6, 7, 8, 10, Tinter1 = 60 for NCSG pattern IDs 2, 4, 6, 7, 10, and Tinter1 = 30 for NCSG pattern IDs 3 and 8 shall be used.
NOTE 2:
NCSG pattern configurations applicability is as specified in Table 9.1.2C-1.
^{NOTE 3}
This NCSG pattern is applicable for E-UTRA inter-frequency measurements only if NCSG based NR measurements are also configured.

For inter-RAT measurements without a MG, the requirements on the cell identification and measurement reporting can be independent with measurement pattern. In these embodiments, new requirements on the cell identification and measurement reporting for inter-RAT measurements without MG may be specified. Moreover, there are also some impacts on CSSF factor because of the inter-RAT measurements without measurement gaps especially for CSSF_outside_gap.

In some embodiments, the potential impact on CSSF requirements (e.g. CSSF_outside_gap) under inter-RAT measurements without a MG. In some embodiments, a scheduling restriction can be introduced due to 3 fundamental issues.
Simultaneous Tx on the serving cell and Rx (measurement) on the target carrier
Mix-numerology between data and measurement objects
The need of Rx beam sweeping in FR2

In these embodiments, for inter-RAT measurements without measurement gaps, the restrictions on the scheduling availability are considered. In these embodiments, the existing scheduling availability specified for intra-frequency measurements in TS 38.133 section 9.2.5.3 can also be applied to the inter-RAT measurements without measurement gaps as starting point.

Some embodiments are directed to a user equipment (UE) configured for operation in a 5G NR network. In these embodiments, the UE may be capable of operating in accordance two or more radio-access technologies (RATs) including a first RAT and a second RAT. In these embodiments, the UE may encode a UE capability information element for transmission to a serving cell. The UE capability information element may indicate whether the UE has a capability for performing inter-RAT measurements without measurement gaps. In these embodiments, when the UE indicated the capability for performing inter-RAT measurements without measurement gaps, the UE may be configured to simultaneously measure signals of the second RAT in a second frequency band while receiving data or while transmitting data in accordance with the first RAT in a first frequency band.

In some embodiments, when the UE is performing inter-RAT measurements without measurement gaps, the UE may be configured to temporarily pause transmission of acknowledgements (ACKs) and negative ACKs (NACKs) (ACK/NACKs) for the data received in accordance with the first RAT during the measurement of the signals of the second RAT.

In these embodiments, for pausing the transmission of ACK/NACKs, no more than a maximum number of the transmission of ACK/NACKs are not transmitted and/or the transmission of ACK/NACKs is paused for a period of time that is less than a predetermined maximum. The pausing of transmission of ACK/NACKs, for example, may allow the UE time to retune a vacant RF chain to the second frequency band, as described in more detail below.

In some embodiments, when the first RAT is associated with a 4G LTE network and the second RAT is associated with the 5G NR network and when the serving cell is a 4G LTE cell: the signals measured of the second RAT comprise synchronization signal block (SSB) of a 5G NR cell for handoff from the 4G LTE cell to the 5G NR cell and the first frequency band is an LTE frequency band (i.e., a E-UTRA band and the second frequency band is a 5G NR frequency band. In these embodiments, the first RAT may use a subcarrier spacing of 15 kHz and the second RAT may use a subcarrier spacing of 30 kHz, although the scope of the embodiments is not limited in this respect.

In some embodiments, when the UE has not indicated the capability for performing inter-RAT measurements without measurement gaps or when the UE does not have the capability for performing inter-RAT measurements without measurement gaps, the UE may encode an inter-RAT-Need For Gaps Information Element (i.e., NeedForGapsInfoNR IE) for transmission to the serving cell indicating that the UE needs downlink measurement gaps for inter-RAT measurements (i.e., to measure signals of the second RAT in the second frequency band). In these embodiments, the UE may decode a measurement gap configuration information element received from the serving cell to configure the UE with measurement gaps. The UE may measure signals of the second RAT during the configured measurement gaps. The UE may be configured to receive the data of the first RAT outside of the configured measurement gaps. In these embodiments, during the configured measurement gaps, the UE may refrain from receiving or transmitting data. In these embodiments, the UE is not scheduled to transmit or received data during the configured measurement gaps. An example of measurement gaps is illustrated in FIG. 2.

In some embodiments, the UE capability information element is a Measurement and Mobility Parameters (MeasAndMobParameters) information element used to convey UE capabilities related to measurements for radio resource management (RRM), radio link monitoring (RLM) and mobility including handover.

In some embodiments, UE may be configured to refrain from sending the inter-RAT-Need For Gaps Information Element when the UE is capable of performing inter-RAT measurements without measurement gaps (i.e., because the UE has the capability to perform inter-RAT measurements without measurement gaps).

In some embodiments, when the UE is operating in a single-carrier (SC) mode, the UE may encode the UE capability information element to indicate that the UE has the capability for performing inter-RAT measurements without measurement gaps. In these embodiments, when the UE is operating in a multi-carrier (MC) mode, the UE may refrain from encoding the UE capability information element to indicate that the UE has the capability for performing inter-RAT measurements without measurement gaps. In these embodiments, the MC mode may comprise dual carrier modes including modes in which the UE is configured for one or more of carrier aggregation (CA) operation and dual connectivity (DC) operation. In these embodiments, when the UE is configured for multi-carrier or dual carrier operations, the UE may not be able to perform inter-RAT measurements without measurement gaps.

In some embodiments, the UE may comprise two or more radio-frequency (RF) chains. In these embodiments, to configure the UE to simultaneously measure signals of the second RAT in the second frequency band while receiving data in accordance with the first RAT in the first frequency band, the UE may tune a vacant RF chain of the two or more RF chains to the second frequency band. In these embodiments, the vacant RF chain may be an actual RF chain or a virtual RF chain. In these embodiments, the UE may have a vacant RF chain when operating in a single carrier mode. In these embodiments, when the UE is operating in a multi-carrier (MC) mode, the UE may not have an RF chain that is vacant, although the scope of the embodiments is not limited in this respect.

In some embodiments, when the first RAT is associated with the 5G NR network and the second RAT is associated with a 4G LTE network, and when the serving cell is a 5G NR cell, the signals measured in accordance with the second RAT comprise cell-specific reference signals (CRS) of the 4G LTE cell for handoff from the 5G NR cell to the 4G LTE cell. In these embodiments, the first frequency band may be a 5G NR frequency band and the second frequency band may be a 4G LTE frequency band.

In some embodiments, when the CRS of the 4G cell are within an active downlink bandwidth part (DL-BWP) of the UE, the UE may refrain from sending an inter-RAT-Need For Gaps Information Element and may be configured to measure the CRS of the 4G cell without measurement gaps during the active DL-BWP.

Some embodiments are directed to computer-readable storage medium that stores instructions for execution by processing circuitry of a user equipment (UE) configured for operation in a 5G NR network. In these embodiments, the UE may be capable of operating in accordance two or more radio-access technologies (RATs) including a first RAT and a second RAT. In these embodiments, the processing circuitry may encode a UE capability information element for transmission to a serving cell, the UE capability information element indicating whether the UE has a capability for performing inter-RAT measurements without measurement gaps. In these embodiments, when the UE indicated the capability for performing inter-RAT measurements without measurement gaps, the processing circuitry may configure the UE to simultaneously measure signals of the second RAT in a second frequency band while receiving data or while transmitting data in accordance with the first RAT in a first frequency band.

Some embodiments are directed to a base station. In these embodiments, the base station may decode a UE capability information element received from a user equipment (UE) at a serving cell. The UE may be capable of operating in accordance two or more radio-access technologies (RATs) including a first RAT and a second RAT. The UE capability information element may indicate whether the UE has a capability for performing inter-RAT measurements without measurement gaps. In these embodiments, when the UE indicated the capability for performing inter-RAT measurements without measurement gaps, the base station may allow for a pausing of a transmission of acknowledgements (ACKs) and negative ACKs (NACKs) (ACK/NACKs) by the UE for data received in accordance with a first RAT during measurements of signals of a second RAT. In these embodiments, for pausing the transmission of ACK/NACKs, no more than a maximum number of the transmission of ACK/NACKs are not transmitted and/or the transmission of ACK/NACKs may be paused for a period of time that is less than a predetermined maximum.

In these embodiments, the UE is configured to simultaneously measure signals of the second RAT in a second frequency band while receiving data or while transmitting data in accordance with the first RAT in a first frequency band. In these embodiments, when the UE is performing inter-RAT measurements without measurement gaps, the processing circuitry is to configure the UE to temporarily pause transmission of acknowledgements (ACKs) and negative ACKs (NACKs) (ACK/NACKs) for the data received in accordance with the first RAT during the measurement of the signals of the second RAT.

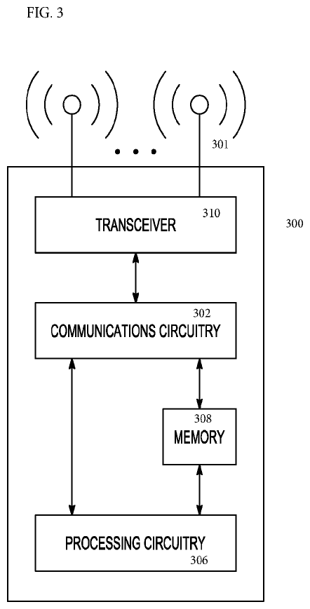

FIG. 3 illustrates a functional block diagram of a wireless communication device, in accordance with some embodiments. Wireless communication device 300 may be suitable for use as a UE or gNB configured for operation in a 5G NR or 6G network.

The wireless communication device 300 may include communications circuitry 302 and a transceiver 310 for transmitting and receiving signals to and from other communication devices using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The wireless communication device 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In accordance with some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 306 of the wireless communication device 300 may include one or more processors. In other embodiments, two or more antennas 301 may be coupled to the communications circuitry 302 arranged for sending and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the wireless communication device 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 300 may include one or more of a keyboard, a display, a non-volatile memory port, multiple antennas, a graphics processor, an application processor, speakers, and other mobile device elements. The display may be an LCD screen including a touch screen.

Although the wireless communication device 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 300 may refer to one or more processes operating on one or more processing elements.

Some embodiments are directed to a method to define UE capability to support inter-RAT measurements without measurement gaps. In some embodiments, the basic indication of supporting inter-RAT without measurement gaps is defined. In some of these embodiments, the capability to support the mixed numerology between the different RATs is defined. In some embodiments, a capability of UE searcher processing is also defined.

In some embodiments, an inter-RAT E-UTRAN measurement may consider the case when LTE CRS to be measured is contained in UE's active BWP. In some embodiments, an inter-RAT NR measurement may consider the case when NR and LTE are operated in the same band.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1.-20. (canceled)

21. An apparatus for a user equipment (UE) configured for operation in a fifth-generation new radio (5G NR) network, the apparatus comprising: processing circuitry; and memory, wherein the processing circuitry is configured to:
encode a UE capability information element for transmission to the network indicating that the UE has a capability for performing inter-RAT measurements without measurement gaps;
decode signalling from the network, the signalling to configure the UE to perform inter-RAT measurements;
wherein when the UE is configured with a measurement gap pattern comprising measurement gaps, the processing circuitry is to:
configure the UE to perform an inter-RAT measurement outside of the measurement gaps when there is no scheduling restriction, and
configure the UE to perform the inter-RAT measurement within the measurement gaps when there is a scheduling restriction.

22. The apparatus of claim 21, wherein the processing circuitry is further configured to encode the UE capability information element for transmission to the network to indicate whether the UE has a capability for simultaneous reception of NR data and a EUTRAN cell-specific reference signal (CRS) with different subcarrier spacings.

23. The apparatus of claim 22, wherein when the UE is to perform the inter-RAT measurement outside of the measurement gaps, the processing circuitry configures the UE to measure a CRS on a EUTRAN cell concurrently with reception of a NR data channel in an active downlink (DL) bandwidth part (BWP) of a NR serving cell of the UE.

24. The apparatus of claim 23, wherein when the UE has indicated the capability for simultaneous reception of NR data and a EUTRAN CRS with different subcarrier spacings, the processing circuitry configures the UE to measure a CRS on a EUTRAN cell concurrently with reception of a NR data channel in an active downlink (DL) bandwidth part (BWP) of a NR serving cell of the UE, the EUTRAN cell and the DL BWP of the NR serving cell using different subcarrier spacing.

25. The apparatus of claim 23, wherein when the UE has not indicated the capability for simultaneous reception of NR data and a EUTRAN CRS with different subcarrier spacings, the processing circuitry is configured to further determine that there is a scheduling restriction when a EUTRAN carrier associated with the EUTRAN cell and the NR data channel have different subcarrier spacings.

26. The apparatus of claim 25, wherein when the EUTRAN carrier and the NR data channel have different subcarrier spacings, the EUTRAN carrier has a subcarrier spacing of 15 kHz and the NR data channel has a subcarrier spacing of one of 15 kHz and 30 kHz.

27. The apparatus of claim 24, wherein the processing circuitry is configured to determine if there is a scheduling restriction based on whether an EUTRAN carrier associated with the EUTRAN cell is overlapping with the active DL BWP of the NR serving cell.

28. The apparatus of claim 24, wherein the processing circuitry is further configured to encode the UE capability information element to include an NeedForGap information element indicating that no gap is needed for an inter-RAT EUTRAN measurement.

29. The apparatus of claim 21, wherein the UE capability information element is a Measurement and Mobility Parameters (MeasAndMobParameters) information element (IE) to convey UE capabilities related to measurements for radio resource management (RRM), radio link monitoring (RLM) and mobility.

30. The apparatus of claim 29, wherein the MeasAndMobParameters IE is encoded to:
indicate whether the UE has the capability for performing inter-RAT measurements without measurement gaps;
indicate whether the UE has a capability for simultaneous reception of NR data and a EUTRAN cell-specific reference signal (CRS) with different subcarrier spacings; and
include a NeedForGap information element indicating that no gap is needed for an inter-RAT EUTRAN measurement.

31. A non-transitory computer-readable storage medium that stores instructions for execution by processing circuitry of a user equipment (UE) configured for operation in a fifth-generation new radio (5G NR) network, wherein the processing circuitry is configured to:
encode a UE capability information element for transmission to the network indicating that the UE has a capability for performing inter-RAT measurements without measurement gaps;
decode signalling from the network, the signalling to configure the UE to perform inter-RAT measurements;
wherein when the UE is configured with a measurement gap pattern comprising measurement gaps, the processing circuitry is to:
configure the UE to perform an inter-RAT measurement outside of the measurement gaps when there is no scheduling restriction, and
configure the UE to perform the inter-RAT measurement within the measurement gaps when there is a scheduling restriction.

32. The non-transitory computer-readable storage medium of claim 31, wherein the processing circuitry is further configured to encode the UE capability information element for transmission to the network to indicate whether the UE has a capability for simultaneous reception of NR data and a EUTRAN cell-specific reference signal (CRS) with different subcarrier spacings.

33. The non-transitory computer-readable storage medium of claim 32, wherein when the UE is to perform the inter-RAT measurement outside of the measurement gaps, the processing circuitry configures the UE to measure a CRS on a EUTRAN cell concurrently with reception of a NR data channel in an active downlink (DL) bandwidth part (BWP) of a NR serving cell of the UE.

34. The non-transitory computer-readable storage medium of claim 33, wherein when the UE has indicated the capability for simultaneous reception of NR data and a EUTRAN CRS with different subcarrier spacings, the processing circuitry configures the UE to measure a CRS on a EUTRAN cell concurrently with reception of a NR data channel in an active downlink (DL) bandwidth part (BWP) of a NR serving cell of the UE, the EUTRAN cell and the DL BWP of the NR serving cell using different subcarrier spacing.

35. The non-transitory computer-readable storage medium of claim 33, wherein when the UE has not indicated the capability for simultaneous reception of NR data and a EUTRAN CRS with different subcarrier spacings, the processing circuitry is configured to further determine that there is a scheduling restriction when a EUTRAN carrier associated with the EUTRAN cell and the NR data channel have different subcarrier spacings.

36. The non-transitory computer-readable storage medium of claim 35, wherein when the EUTRAN carrier and the NR data channel have different subcarrier spacings, the EUTRAN carrier has a subcarrier spacing of 15 kHz and the NR data channel has a subcarrier spacing of one of 15 kHz and 30 kHz.

37. The non-transitory computer-readable storage medium of claim 34, wherein the processing circuitry is configured to determine if there is a scheduling restriction based on whether an EUTRAN carrier associated with the EUTRAN cell is overlapping with the active DL BWP of the NR serving cell.

38. The non-transitory computer-readable storage medium of claim 34, wherein the processing circuitry is further configured to encode the UE capability information element to include an NeedForGap information element indicating that no gap is needed for an inter-RAT EUTRAN measurement.

39. A user equipment (UE) configured for operation in a fifth-generation new radio (5G NR) network, the UE comprising: processing circuitry; and memory, wherein the processing circuitry is configured to:
encode a UE capability information element for transmission to the network indicating that the UE has a capability for performing inter-RAT measurements without measurement gaps;
decode signalling from the network, the signalling to configure the UE to perform inter-RAT measurements;
wherein when the UE is configured with a measurement gap pattern comprising measurement gaps, the processing circuitry is to:
configure the UE to perform an inter-RAT measurement outside of the measurement gaps when there is no scheduling restriction, and
configure the UE to perform the inter-RAT measurement within the measurement gaps when there is a scheduling restriction.

40. The UE of claim 39, wherein the processing circuitry is further configured to encode the UE capability information element for transmission to the network to indicate whether the UE has a capability for simultaneous reception of NR data and a EUTRAN cell-specific reference signal (CRS) with different subcarrier spacings.
